(19) United States
(12) Patent Application Publication
(10) Pub. No.: US 2024/0319977 A1
(43) Pub. Date: Sep. 26, 2024

(54) METHOD AND SYSTEM FOR CENTRALIZED SOFTWARE DEPLOYMENT TO MOBILE DEVICES

(71) Applicant: Quanta Cloud Technology Inc., Taipei City (TW)

(72) Inventors: Yen-Hsun Chen, Taipei City (TW); Jia-Yu Juang, Taipei City (TW); Chi-Yuan Yen, Taipei City (TW); Tong-Pai Huang, Taipei City (TW); Chia-Jui Lee, Taipei City (TW)

(21) Appl. No.: 18/188,275

(22) Filed: Mar. 22, 2023

(51) Int. Cl. G06F 8/61

(52) U.S. Cl. CPC G06F 8/61

(57) ABSTRACT

A system and method for deploying software packages for end devices that communicate through a mobile network is disclosed. A deployment orchestrator is coupled to the mobile network. End devices communicate with each other through the mobile network. At least one of end devices includes a support package repository storing software packages. When a new end device requires software package deployment, the deployment orchestrator locates at least one of the end devices with the support package repository. The new end device receives software packages from the end device including the support package repository through the mobile network.

### TECHNICAL FIELD

The present disclosure relates generally to firmware management for computing devices. More particularly, aspects of this disclosure relate to a system that provides a mechanism for updating software through a mobile network for mobile devices.

### BACKGROUND

Networked computer devices have traditionally in fixed locations such as data centers. Networks may thus be wired or unwired such as a WiFi network. Computing devices in mobile situations may be networked as part of a wireless network, but since wireless access points do not offer comprehensive coverage over large areas, network functions are severely curtailed when relying on a WiFi network. As the general-purpose devices (e.g., controllers, servers and the like) equipped with mobile modules are more and more popular, networks have been generally adopted from wired networks to wireless networks. This offers much more comprehensive coverage thereby enhancing functionality over large areas that a device might be moved. With the advent of mobile communication systems such as 5G, computing devices in mobile environments such as vehicles may access networks. For example, there may be networked computing devices on vehicles in environments such as coastal vessels, patrol cars, and the like may be used for a wide variety of functions. Such 5G enabled devices may operate as controllers, computers, or other devices that require software packages to perform the functions. Such devices often operate different hardware (e.g., webcam and Wi-Fi adaptor) for purposes such as surveillance and wireless access point for IP sharing. Thus, mobile networks have been becoming the dominant underlying deployment network for unattended mass software deployment to such devices.

However, developers have encountered three issues when adopting mobile network for software deployment on devices that may be moved between locations. First, the bandwidth of a mobile network is limited compared to a traditional wire based local area network (LAN). The limited bandwidth causes mass software deployment on devices to become a time-consuming task. Second, when devices physically move during software deployment, the Internet connection to the device can dynamically change, which can interrupt the downloading process of software package and result in unexpected errors. Third, in real practice, customers attach additional hardware components (e.g., a camera or a microphone) to the general-purpose devices for specific use cases. The additional hardware components result in complicating the deployment process to fulfill diverse use cases, specifically for mass deployment of software to numerous end devices with different hardware requirements.

Thus, there is a need for a system that allows reliable deployment of software to a set of mobile networked devices. There is another need for a system that allows reliable deployment despite devices shifting to different IP addresses in a mobile network. There is another need for a system to minimize bandwidth requirements in software package deployment from a central repository.

### SUMMARY

One disclosed example is a software deployment system including a deployment orchestrator coupled to a mobile network. A plurality of end devices communicating with each other through the mobile network. At least one of the end devices includes a support package repository storing software packages. When a new end device requires software package deployment, the deployment orchestrator locates the end device with the support package repository. The new end device receives software packages from the end device including the support package repository through the mobile network.

A further implementation of the example system is an embodiment where the deployment orchestrator includes a database including hardware information and location information for each of the end devices. Another implementation is where the new end device includes specific hardware requiring specific software packages. The specific hardware includes at least one of the group of a camera, a microphone, and a Wi-Fi adaptor. The hardware information in the database of the new end device includes the specific hardware. Another implementation is where the deployment orchestrator includes a package selector that determines software packages to support the specific hardware of the new end device. Another implementation is where the deployment orchestrator includes a central repository including software packages required by any of the plurality of end devices. Another implementation is where the deployment orchestrator creates a support package repository in one of the end devices from the central repository. Another implementation is where the deployment orchestrator allows connection to the central repository for the deployment of software packages when no end device with a support package repository is available to the new end device. Another implementation is where the deployment orchestrator includes a deployment conductor that collects the location of the new end device and the location of the at least one end device with the support package repository. Another implementation is where the deployment orchestrator includes an alive agent monitor that determines whether the location of the end device including the support package repository has changed. The alive agent monitor alerts the deployment conductor and locates another end device including the support package repository. Another implementation is where the deployment of software packages to the new end device is initiated by the at least one end device and continued by the another end device.

Another disclosed example is a method of deploying software packages to a new end device in communication with a mobile network. A support package repository is created in an end device of a plurality of end devices in communication with the mobile network. The support package repository storing software packages from a deployment orchestrator. It is determined that the new end device requires software deployment. The location of the new end device and the end device having the support package repository are determined. The software packages are deployed from the support package repository of the end device to the new end device.

Another implementation of the example method includes storing hardware information and location information for each of the plurality of end devices in a database. Another implementation is where the new end device includes specific hardware requiring specific software packages. The specific hardware includes at least one of a camera, a microphone, and a Wi-Fi adaptor. The hardware information in the database of the new end device includes the specific hardware. Another implementation is where the software packages are determined based on the hardware information of the new end device in the database. Another implementation is where the example method includes storing all software packages required by the end devices in a central repository. Another implementation is where the example method includes connecting the new device to the central repository for the deployment of software packages when no end device with a support package repository is available to the new end device. Another implementation is where the example method includes collecting location data of the new end device and the location of the end device with the support package repository. Another implementation is where the example method includes determining whether the location of the end device including the support package repository has changed. The example method also includes locating another end device including the support package repository. Another implementation is where the deployment of software packages to the new end device is initiated by end device and continued by the located another end device.

Another disclosed example is a deployment orchestrator for deployment of software to a new end device coupled to a mobile network. The deployment orchestrator includes a central repository storing software packages and a deployment conductor coupled to the central repository. The deployment orchestrator includes a mobile network interface allowing communication between the deployment conductor and a plurality of end devices. The end devices include an end device with a support package repository storing software packages from the central repository. The deployment conductor receives a notification of a new end device in communication with the mobile network. The deployment orchestrator includes a package selector coupled to the deployment conductor. The package selector determines software packages for the new end device. A location selector is coupled to the deployment conductor. The location selector determines the location of the new end device and the locations of the end devices. The deployment conductor causes deployment of software packages from the end device to the new end device.

The above summary is not intended to represent each embodiment or every aspect of the present disclosure. Rather, the foregoing summary merely provides an example of some of the novel aspects and features set forth herein. The above features and advantages, and other features and advantages of the present disclosure, will be readily apparent from the following detailed description of representative embodiments and modes for carrying out the present invention, when taken in connection with the accompanying drawings and the appended claims.

### BRIEF DESCRIPTION OF THE DRAWINGS

The disclosure will be better understood from the following description of exemplary embodiments together with reference to the accompanying drawings, in which:

FIG. 1 is a block diagram of a system that allows deployment of software to end devices that may move locations and access a mobile network;

FIG. 2 shows the process of deployment of software via the system in FIG. 1 using components of the deployment orchestrator, an end device having a support package repository, and a new end device;

FIG. 3 is a block diagram of the example system in FIG. 1 showing the deployment of software when a different end device with a support package repository is employed;

FIG. 4 is an example table showing hardware information of an end device;

FIG. 5 is an example table showing rules for deployment of software packages according to the hardware information in FIG. 4;

FIG. 6 is a flow diagram of an example package selector that allows deployment of software specific to hardware on an end device in FIG. 1;

FIG. 7 is a flow diagram of an example location selection routine executed by the location selector in FIG. 1;

FIG. 8 is a flow diagram of an example agent alive monitor routine executed by the alive agent monitor in FIG. 1; and

FIGS. 9-10 are block diagrams of computer systems to implement the processes described herein.

The present disclosure is susceptible to various modifications and alternative forms. Some representative embodiments have been shown by way of example in the drawings and will be described in detail herein. It should be understood, however, that the invention is not intended to be limited to the particular forms disclosed. Rather, the disclosure is to cover all modifications, equivalents, and alternatives falling within the spirit and scope of the invention as defined by the appended claims.

### DETAILED DESCRIPTION OF THE ILLUSTRATED EMBODIMENTS

The present inventions can be embodied in many different forms. Representative embodiments are shown in the drawings, and will herein be described in detail. The present disclosure is an example or illustration of the principles of the present disclosure, and is not intended to limit the broad aspects of the disclosure to the embodiments illustrated. To that extent, elements and limitations that are disclosed, for example, in the Abstract, Summary, and Detailed Description sections, but not explicitly set forth in the claims, should not be incorporated into the claims, singly or collectively, by implication, inference, or otherwise. For purposes of the present detailed description, unless specifically disclaimed, the singular includes the plural and vice versa; and the word “including” means “including without limitation.” Moreover, words of approximation, such as “about,” “almost,” “substantially,” “approximately,” and the like, can be used herein to mean “at,” “near,” or “nearly at,” or “within 3-5% of,” or “within acceptable manufacturing tolerances,” or any logical combination thereof, for example.

A client-server deployment architecture is proposed to address the three issues of limited bandwidth in wireless networks, the possibility of movement of the device, and the variety of hardware support requirements. The architecture is composed of a server and end devices that each may be mobile. The end devices communicate with the base stations of a mobile network. In the server, a deployment orchestrator module is in charge of controlling the deployment process and providing a central package repository that may be deployed to one or more of the mobile end devices. In the end devices, a deployment agent executes each command sent from central deployment orchestrator. Subsequently, each end device may serve as a support package repository for new end devices.

In order to solve the problem of low bandwidth, some of the end devices with an operating system (OS) and applications deployed initially serve as a support package repository that stores software packages. This allows other new end devices to download the software packages from support package repository on the end device instead of from the central package repository of the server. The deployment orchestrator assigns a nearby end device with a support package repository by utilizing geographical location information. In this manner, download traffic to new end devices can be offloaded from the server to an end device in an efficient way.

In order to solve end device mobility effecting network connection quality, the deployment orchestrator periodically synchronizes the availability of each end device with a support package repository as the IP addresses of such end devices dynamically change. When the IP address change occurs, the deployment orchestrator can instruct the affected new end devices to switch to download from another end device with a support package repository and resume the package download.

In order to address a diversity of hardware in new end devices, the deployment orchestrator analyzes the device information (i.e., feature and location) so that the deployment orchestrator can centrally control and manage the deployment process for diverse use cases.

The example client-server deployment architecture allows users to efficiently achieve mass software deployment on devices over a mobile network. The deployment orchestrator allows users to easily manage the complicated deployment process and avoid human errors caused by human intervention for a wide variety of use cases. Users only need to power on the new end devices to initiate the deployment process from an end device in proximity with a support package repository. During the deployment process, the deployment orchestrator can dynamically detect an IP address change of the end device and notify the deployed devices to download an appropriate package repository from another end device so that the initial device with the support package repository does not need to stay in an area proximate the end devices.

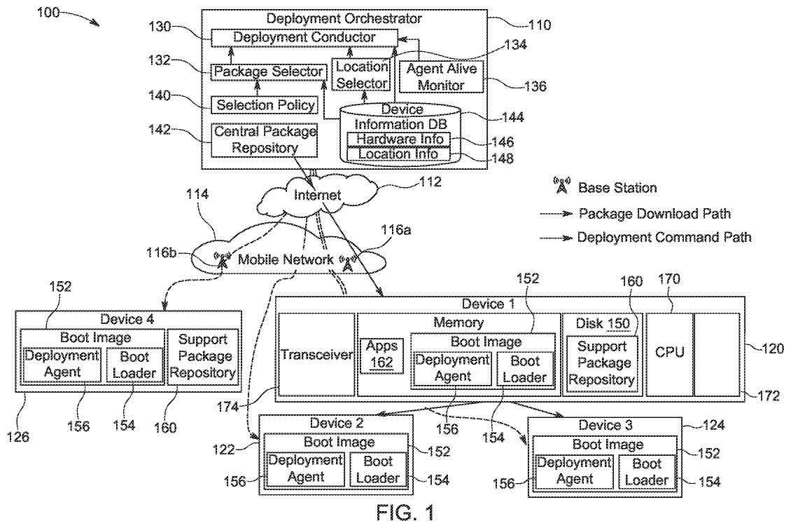

FIG. 1 shows an example architecture 100 with a deployment orchestrator 110 that has access to the Internet 112 and a mobile network 114. The architecture 100 includes end devices 120, 122, 124, and 126 that access the Internet 112 through the mobile network 114. In this example, the mobile network 114 relies on a series of base stations 116a and 116b that allow connection of different mobile devices such as end devices 120, 122, 124 that may be in proximity to one of the base stations such as the base station 116a. In this example, the mobile network 114 may be a 5G mobile network or a LTE (4G) mobile network.

The end devices 120, 122, 124, 126 can access the Internet 112 through communicating with one of the base stations 116a or 116b of the mobile network 114. The end device thus has the IP address assigned by the base station. The deployment orchestrator 110 resides on the Internet 112 with a public IP address, which can be accessed by any devices via the Internet 112. The deployment orchestrator 110 includes a deployment conductor 130, a package selector 132, a location selector 134, and an agent alive monitor 136. Different data components include a selection policy 140, a central package repository 142, and a device information database 144. The deployment conductor 130 controls the whole process of deployment of software to the end devices. The package selector 132 chooses the package set and command set according to the selection policy 140. The selection policy 140 is a rule table provided to find out the correspondence between a package and the command set and hardware features of each device.

As will be explained, the location selector 134 chooses a device that has the appropriate support package repository to download packages according to the location of another end device. In this example, two of the devices 120 and 126 have support package repositories. The agent alive monitor 136 periodically checks the availability of each support package repository and notifies the deployment conductor 130 when a support package repository is not available.

The central package repository 142 is a central repository with all software packages for deployment to end devices such as the devices 120, 122, 124, and 126. The device information database 144 is a database that stores hardware information 146 and location information 148 such as geographical location and cell identification for each end device. Each time a new end device is first powered on, the newly added device can automatically connect to the mobile network 114 and communicate with the deployment conductor 130. Subsequently, the development conductor 130 can get the geographical information from a deployment agent in the end device so that the geographical information can be stored in the database 144 of the deployment orchestrator 110. The geographical information is updated every time the end device is powered on or the IP of the end device is changed. The geographical information is given by the base station and stored in the end device when the new end device connects to the base station or when an end device that has changed IP address connects to the base station.

Each of the end devices, such as the end device 120, include a memory 150 that loads a boot image 152. The boot image 152 includes a boot loader 154, and a deployment agent 156. The memory 150 in this example may also load applications 162 in the end devices such as the devices 120 and 126. A support package repository 160 is statically stored in the disks of the devices 120 and 126. Certain of the end devices such as the devices 122 and 124 do not include the support package repository 160. The end devices such as the end device 120 also include a processor 170 that executes applications 162. As will be explained, the end devices such as the end device 120 may include different interfaces 172 that allow control of additional hardware such as cameras, microphones, sensors, Wi-Fi adaptors and the like. The end device 120 also includes a transceiver 174 that may communicate with the mobile network 114.

Each new end device is preloaded the same boot image 152 that contains the boot loader 154 and the deployment agent 156. When a new end device is powered on, the boot loader 154 is loaded into memory, then handles the boot process, and activates the mobile module transceiver 174 to connect to a nearby cellular base station such as the base station 116a. After the boot loader 154 establishes a mobile connection between a base station and the end device, the deployment agent 156 can access the internet 112 via the mobile network 114 and establish a control connection to the deployment orchestrator 110 to execute the control commands sent from the deployment conductor 130. As will be explained, existing end devices with a support package repository 160 allow the deployment of software packages to the new end device without accessing the central repository of the deployment conductor 130.

The end devices such as the end devices 120 and 126 uses a storage device such as a disk to store the support package repository 160 that may provide deployment packages of software for other end devices to download. The deployment orchestrator 110 chooses the support package repository from the nearest end device for a newly added end device according to the geographic information. The nearest end device thus may download the support package repository to the newly added end device. The content of the support package repository is downloaded from either the central or support package repository and is then saved in the storage device such as a disk during the deployment process of the end device. The content of a support package repository is downloaded only once and is not updated. Each end device thus has a support package repository after package deployment. As will be explained, the support package repository 160 may be activated by the deployment conductor 130 for one of the devices such as the device 120 to allow other devices such as the devices 122 and 124 to obtain software packages required for deployment. The deployment conductor 130 will assign an end device such as the end device 120 that is within range of the base station 116a that is connected to the new end device (e.g., end device 122 or 124) to establish a connection. The software packages from the support package repository 160 of the device 120 will be sent through the mobile network 114 to a new device.

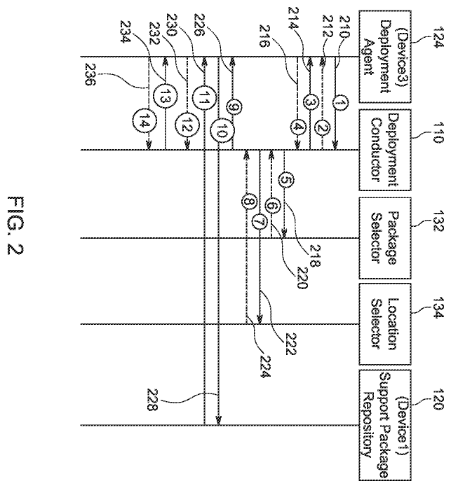

FIG. 2 shows the process of deploying software between a first end device such as the end device 120 that has a support package repository 160 and another end device such as the end device 124 which is a new device in this example. The process also involves the deployment conductor 130, the package selector 132, and the location selector 134 of the deployment orchestrator 110 in FIG. 1. Before initiating the deployment, the support package repository 160 in the end device 120 stores different software packages derived from the central package repository 142. The software packages are stored in the support package repository 160 during the deployment of the end device 120.

The end device 124 is powered on and the boot image 152 is loaded. Afterward, the boot loader 154 in the end device connects a base station such as the base station 116a so that the deployment agent 156 can access the internet 112 via the mobile network 114. The deployment agent 156 proactively initializes building a control connection through the mobile network 114 with the deployment conductor 130 (210). After the deployment conductor 130 receives the requests from end device 124 to establish the control connection, the deployment conductor 130 responds with a control connection established message to the end device 124 (212). The deployment conductor 130 then sends commands to the deployment agent 156 via the control connection to collect hardware and location information of the end device 124 (214). The deployment agent 156 provides the hardware and location information of the end device 124 to the deployment conductor 130 (216). The hardware and location information is also added to the device information database 144 after the deployment conductor 130 receives hardware and location information from the deployment agent 156. After collecting the hardware and location information, the deployment conductor 130 asks the package selector 132 to choose the installation packages based on the hardware information obtained from the end device 124 (218).

The package selector 132 responds with the names of the selected packages for installation (220). After obtaining the names of the packages from the package selector 132, the deployment conductor 130 asks the location selector 134 to choose a package repository for installation based on the location information of the end device 124 (222). The routine determines an end device that is in communication with the end device 124. In this case, the package repository is the end device 120. The location selector 134 responds with the IP address of the selected end device 120 from the database (224). The deployment conductor 130 instructs the deployment agent 156 on the end device 124 to start downloading the packages to be installed (226). The deployment agent 156 starts to download the packages from the support package repository 160 of the end device 120 (228). The deployment agent 156 saves the received packages to the local memory in the end device 124 (230). The deployment agent 156 responds with a message to the deployment conductor 130 that the download is finished (232). After all the packages are downloaded, the deployment conductor 130 instructs the deployment agent 156 of the end device 124 to initiate the installation process with the downloaded packages (234). Once the installation is completed, the deployment agent 156 of the end device 124 responds to the deployment conductor 130 that the installation has been finished (236).

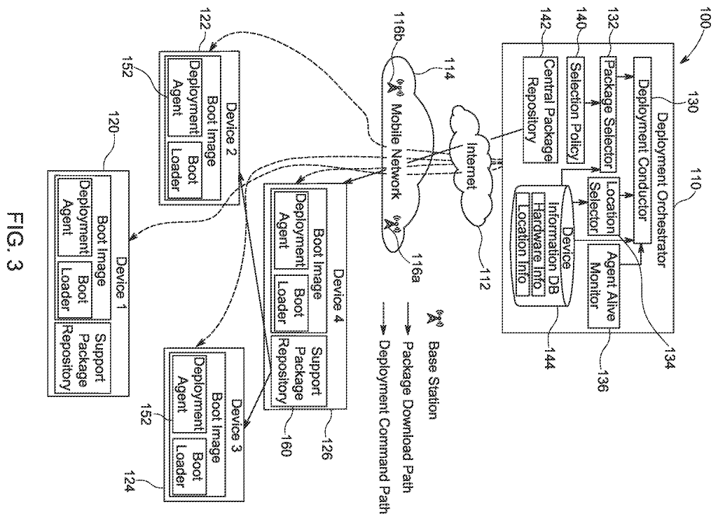

FIG. 3 is a block diagram of the architecture 100 where a different end device serves as the support package repository, replacing the initial end device 120 shown in FIG. 1. In this example, the end device 120 has moved in relation to the other end devices 124 and 126. The location information of the end device 120 is updated to a new location. The agent alive monitor 136 determines that the end device 120 now has a new IP address due to the new location. The deployment conductor 130 determines that the device 120 is no longer available to provide the software packages to new devices such as the end devices 122 and 124. The deployment conductor 130 thus executes a routine to search the database 144 for end devices in proximity to the new devices with a support package repository.

In this example, the device 126 with the support package repository 160 meets the criteria as it is in a location that has the same base station as the end devices 122 and 124. The deployment of software to the devices 122 and 124 thus can either continue through the end device 126 or be initiated from the support package repository 160 in the end device 126.

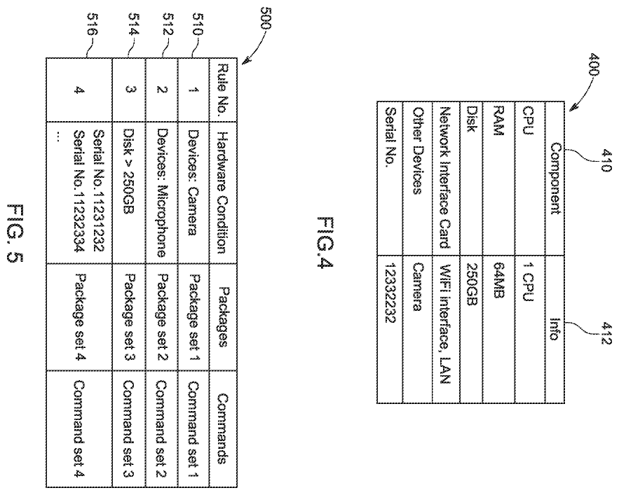

The package selector 132 can dynamically detect and analyze the hardware features of an end device based on the hardware information of the end device. The hardware information is sent to the deployment conductor 130 through the mobile network 114 when a new end device joins the mobile network 114 to communicate with the deployment conductor 156. The package selector 132 is programmed to select corresponding software packages for specific use cases without requiring any human intervention. The package selector 132 may make such selections based on application of different rules based on the hardware information. FIG. 4 shows a table 400 that includes specific hardware information of an end device such as the new end device 124 that may be accessed by the package selector 132. Thus, the table 400 shows a column 410 of components and a column 412 of corresponding information. In this example, the components include the number of CPUs, RAM size, disk size, network interface card capability, all other devices, and the serial number of the device.

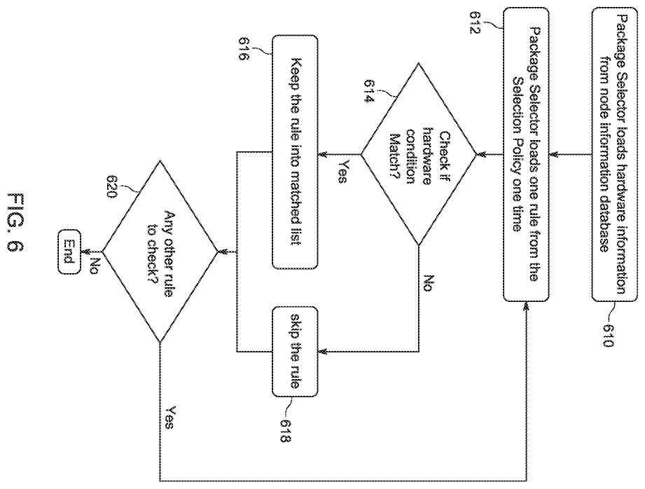

FIG. 5 shows a table 500 of an example set of rules based on the specific hardware information. Each rule has a certain hardware condition and corresponding packages and commands. These commands direct the software installation process such as to copy files to a specific path, to modify the configuration file, and to remove temporary files after installation. In this example, a first rule 510 has a package set and a command set for a hardware device such as a camera. A second rule 512 has a package set and a command set for another hardware devices such as a microphone. There may be multiple other rules corresponding to other hardware devices such as sensors and Wi-Fi adaptors with corresponding software packages and commands. Other hardware conditions may include specific capabilities or identification. For example, a third rule 514 has a package set and a command set for a disk greater than 250 GB. Finally, a fourth rule 516 has a package set and a command set for specific serial numbers of devices. Thus, the routine of the package selector 132 would review the hardware information from the table 400 in FIG. 4 and apply the rules in FIG. 5. In this example, the first rule would be applied because the end device 124 has a camera. The second rule would not be applied because the end device 124 does not have a microphone. The third rule would not be applied, because the disk on the end device 124 is not greater than 250 GB. Finally, the fourth rule would be applied because the serial number of the device 124 matches one of the listed serial numbers. Thus, the package selector 132 would select the first package set and command set and the fourth package set and command set based on the rules in FIG. 5. The selected package sets would then be preferably installed from support package repository 160 of another end device.

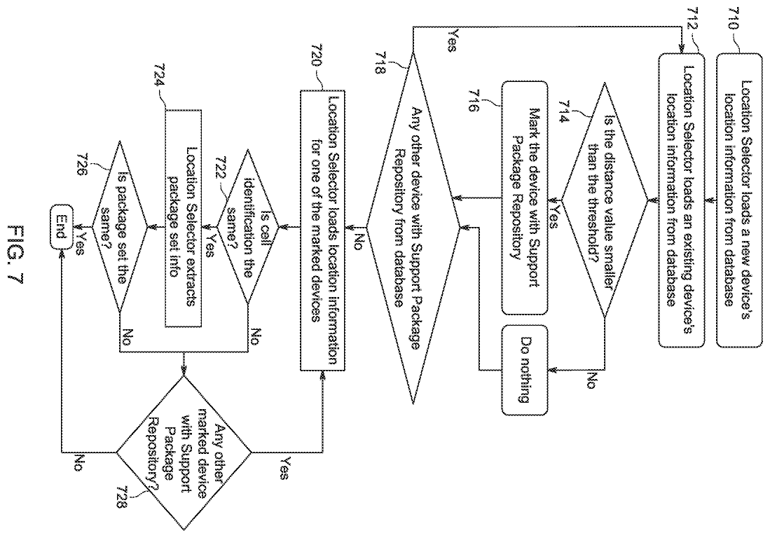

FIG. 6 shows a flow diagram of the routine to determine the selection of packages for a specific device based on information such as the hardware of the device. The package selector 132 first loads the hardware information of the specified device from the device information database 144 (610). The hardware information may include the information shown in the table 400 in FIG. 4. The package selector 132 then loads one rule the from the selection policy such as the first rule 510 in table 500 in FIG. 5 (612). The routine then checks if the hardware information listed in the table satisfies the hardware condition in the selected rule (614). If the hardware condition is satisfied, the rule from the rules is kept (616). If the hardware condition is not satisfied, the rule is skipped (618). After the determination to keep or skip the rule, the routine reviews the selection policy to determine whether there are any other rules to check (620). If there are further rules, the routine loops back to load the next rule (614). The routine continues until all the rules in the policy have been checked. The result is a set of rules that determine the packages that should be installed based on the specific hardware of the end device. As explained above, in the example end device 124, the first rule 510 and the fourth rule 516 are kept for determining the appropriate software packages to be deployed. Such packages may be deployed from another end device such as the end device 120 in FIG. 1 with a support package repository 160 with the selected software packages.

The location selector 134 facilitates selection of an appropriate repository from end devices having support package repositories for downloading of different packages to a new end device. This allows the architecture 100 to avoid end devices having to rely on packages received from the central package repository 142. New end devices do not need to download the deployment packages directly from the central package repository 142, thus minimizing mobile network bandwidth requirements. The example architecture 100 allows new devices to download the packages from any identical existing device with a support package repository. This effectively offloads the network traffic to the deployment orchestrator 110 and saves tremendous time in deployment.

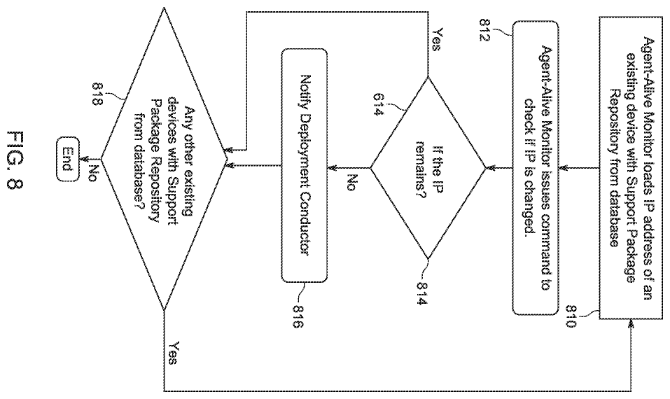

A flow diagram of the location selection routine executed by the location selector 134 is shown in FIG. 7. The location selector 134 loads the location information of a new device, including geographical location (e.g., longitude and latitude) and cell identification. The device database is updated when a new end device connects to the mobile network for the first time and communicates with the deployment conductor through the Internet. The information in the device information database is updated when the end device changes its IP address. When the end device first joins the mobile network or the device changes its IP address from one base station to another base station, the geographical location information is sent from base station to an end device. The geographical location information is stored in the disk of the end device as a file. The geographical location information is delivered to the deployment orchestrator with the assistance of the deployment agent (710). The location selector 134 loads the location information of an existing device with a support package repository (712). The routine checks if the distance value between the new device and the device with support package repository is smaller than a defined threshold (714). The bandwidth has a positive correlation to the threshold setting. If the bandwidth is high, the threshold is set to be relatively high, allowing more end devices in a group to download files concurrently. However, when the bandwidth is low, the threshold is set relatively low, allowing fewer devices to concurrently download files in a group. For example, a mobile network with high bandwidth allows more devices to concurrently download packages; thus, a high threshold is set for a support package repository to provide wider coverage. Otherwise, the low threshold can be set to provide relatively narrow coverage so that the support package repository serves fewer devices to currently download the packages.

If the reviewed device with a support package repository has a distance value that is smaller than the defined threshold, the routine marks the device (716). After marking the device, or if the distance of the device is larger than the threshold, the routine determines whether there are any other devices with a support package repository from the database 144 (718). If there are additional devices, the location selector 134 loads the next existing device with a support package repository from the database (712). If there are no additional devices (718), the location selector 134 loads cell identification information for one of the marked devices (720). The routine then checks if the cell identification of the marked device is the same as that of the new device (722). Cell identification refers to a unique serial number that is assigned to each base station in order to identify each of the base stations exclusively. If the cell identification is the same, the location selector 134 extracts the package set information of the selected device with the support package repository (724). The routine checks if the package set provided by the selected device with support package repository meets the rules kept for the new device (726). If the package set of the selected device meets the kept rules, the routine ends. The package set may then be deployed on command of the deployment conductor 130.

If either the cell identification is different (722) or the package set is different (726), the routine determines whether there are any remaining marked devices with the support package repository (728). If there are remaining marked devices, the routine loops back to load location information for one of the remaining marked devices (720) and checks for cell identification and package set. If there are no remaining marked devices, the routine ends and indicates to the location selector 134 that there are no devices with the sufficient packages for deployment. In this case, the architecture 100 may attempt to access the central package repository 142 to directly download packages for deployment to the new device.

The agent alive monitor 136 allows for resolution of dynamic IP address change of end devices with the support package repository. When an end device with a support package repository is connected to another base station 116 in the mobile network 114 due to location movement, the IP address can be changed. This may interrupt the download process for all newly added end devices receiving packages from the moved end device. Therefore, the agent alive monitor 136 periodically monitors the availability of each end device with a support package repository 160 such as the devices 120 and 126 for the awareness of IP address change event.

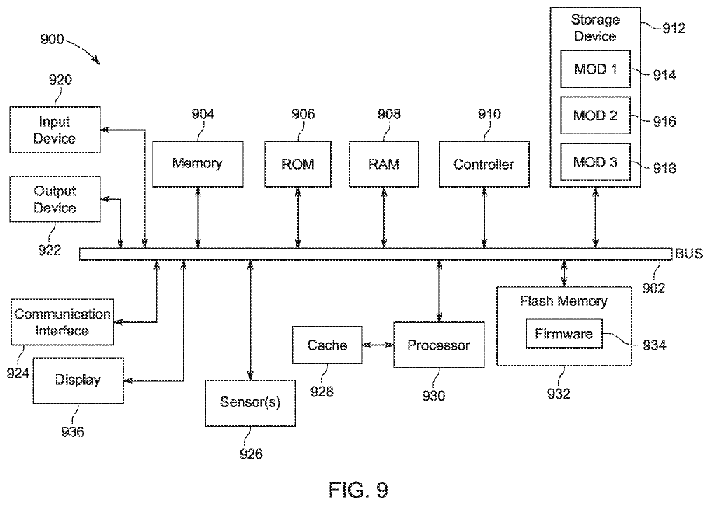

A flow diagram of the availability check routine is shown in FIG. 8. The agent alive monitor 136 periodically gets the IP addresses of the existing end devices storing the support package repository from the database 144. Then, the agent alive monitor 136 collects the current IP addresses of these devices from the deployment agent (810). The agent alive monitor 136 then checks if the IP address of the end device (from the database) has changed based on a comparison with the collected current IP address (812). The routine determines whether the current IP address of the end device is the same as the IP address from the database. If the current IP address of the device is different from the IP address saved in database (814), indicating the end device has moved and can no longer provide the support package repository for download, the routine will notify the deployment conductor 130 (816). By using the routine in FIG. 7, the deployment conductor 130 will reassign another end device with the support package repository to the set of devices that are interrupted downloading the package. Once a connection is established to the new support package repository, the download may resume. If the IP address remains the same (814) or after the deployment conductor 130 is notified, the routine checks the database 144 to see if another available end device with a support package repository exists (818). If another available end device with a support package repository is found, the routine loops to get the IP address of the device from the database (810) and compares the IP address with the current IP address of the device, which is directly collected from the device. If there are no existing devices, the routine ends. Through this routine, the new device can continue to download the package from another end device so as to resolve any service interruption issue with the initial end device with the support package repository.

The flow diagrams in FIGS. 6-8 are representative of example machine readable instructions for the process of locating end devices for deployment of software packages on other end devices. In this example, the machine readable instructions comprise an algorithm for execution by: (a) a processor; (b) a controller; and/or (c) one or more other suitable processing device(s). The algorithm may be embodied in software stored on tangible media such as flash memory, CD-ROM, floppy disk, hard drive, digital video (versatile) disk (DVD), or other memory devices. However, persons of ordinary skill in the art will readily appreciate that the entire algorithm and/or parts thereof can alternatively be executed by a device other than a processor and/or embodied in firmware or dedicated hardware in a well-known manner (e.g., it may be implemented by an application specific integrated circuit [ASIC], a programmable logic device [PLD], a field programmable logic device [FPLD], a field programmable gate array [FPGA], discrete logic, etc.). For example, any or all of the components of the interfaces can be implemented by software, hardware, and/or firmware. Also, some or all of the machine readable instructions represented by the flowcharts may be implemented manually. Further, although the example algorithm is described with reference to the flowcharts illustrated in FIG. 6-8, persons of ordinary skill in the art will readily appreciate that many other methods of implementing the example machine readable instructions may alternatively be used. For example, the order of execution of the blocks may be changed, and/or some of the blocks described may be changed, eliminated, or combined.

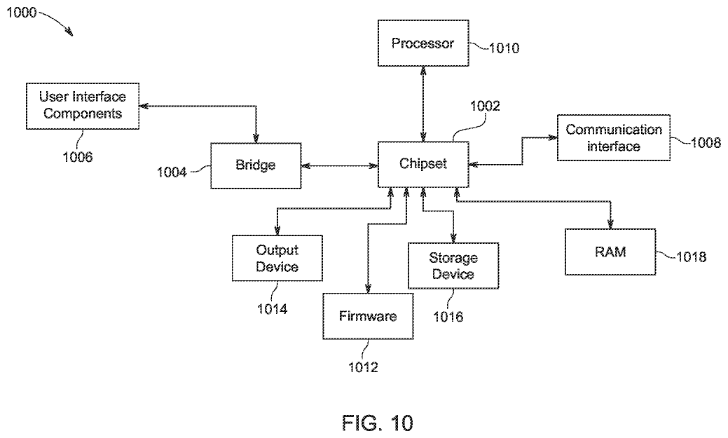

FIG. 9 illustrates an example computing system 900, in which the components of the computing system are in electrical communication with each other using a bus 902. The system 900 includes a processing unit (CPU or processor) 930; and a system bus 902 that couples various system components, including the system memory 904 (e.g., read only memory (ROM) 906 and random access memory (RAM) 908), to the processor 930. The system 900 can include a cache of high-speed memory connected directly with, in close proximity to, or integrated as part of the processor 930. The system 900 can copy data from the memory 904 and/or the storage device 912 to the cache 928 for quick access by the processor 930. In this way, the cache can provide a performance boost for processor 930 while waiting for data. These and other modules can control or be configured to control the processor 930 to perform various actions. Other system memory 904 may be available for use as well. The memory 904 can include multiple different types of memory with different performance characteristics. The processor 930 can include any general purpose processor and a hardware module or software module, such as module 1 914, module 2 916, and module 3 918 embedded in storage device 912. The hardware module or software module is configured to control the processor 930, as well as a special-purpose processor where software instructions are incorporated into the actual processor design. The processor 930 may essentially be a completely self-contained computing system that contains multiple cores or processors, a bus, memory controller, cache, etc. A multi-core processor may be symmetric or asymmetric.

To enable user interaction with the computing device 900, an input device 920 is provided as an input mechanism. The input device 920 can comprise a microphone for speech, a touch-sensitive screen for gesture or graphical input, keyboard, mouse, motion input, and so forth. In some instances, multimodal systems can enable a user to provide multiple types of input to communicate with the system 900. In this example, an output device 922 is also provided. The communications interface 924 can govern and manage the user input and system output.

Storage device 912 can be a non-volatile memory to store data that is accessible by a computer. The storage device 912 can be magnetic cassettes, flash memory cards, solid state memory devices, digital versatile disks, cartridges, random access memories (RAMs) 908, read only memory (ROM) 906, and hybrids thereof.

The controller 910 can be a specialized microcontroller or processor on the system 900, such as a BMC (baseboard management controller). In some cases, the controller 910 can be part of an Intelligent Platform Management Interface (IPMI). Moreover, in some cases, the controller 910 can be embedded on a motherboard or main circuit board of the system 900. The controller 910 can manage the interface between system management software and platform hardware. The controller 910 can also communicate with various system devices and components (internal and/or external), such as controllers or peripheral components, as further described below.

The controller 910 can generate specific responses to notifications, alerts, and/or events, and communicate with remote devices or components (e.g., electronic mail message, network message, etc.) to generate an instruction or command for automatic hardware recovery procedures, etc. An administrator can also remotely communicate with the controller 910 to initiate or conduct specific hardware recovery procedures or operations, as further described below.

The controller 910 can also include a system event log controller and/or storage for managing and maintaining events, alerts, and notifications received by the controller 910. For example, the controller 910 or a system event log controller can receive alerts or notifications from one or more devices and components, and maintain the alerts or notifications in a system event log storage component.

Flash memory 932 can be an electronic non-volatile computer storage medium or chip that can be used by the system 900 for storage and/or data transfer. The flash memory 932 can be electrically erased and/or reprogrammed. Flash memory 932 can include EPROM (erasable programmable read-only memory), EEPROM (electrically erasable programmable read-only memory), ROM, NVRAM, or CMOS (complementary metal-oxide semiconductor), for example. The flash memory 932 can store the firmware 934 executed by the system 900 when the system 900 is first powered on, along with a set of configurations specified for the firmware 934. The flash memory 932 can also store configurations used by the firmware 934.

The firmware 934 can include a Basic Input/Output System or equivalents, such as an EFI (Extensible Firmware Interface) or UEFI (Unified Extensible Firmware Interface). The firmware 934 can be loaded and executed as a sequence program each time the system 900 is started. The firmware 934 can recognize, initialize, and test hardware present in the system 900 based on the set of configurations. The firmware 934 can perform a self-test, such as a POST (Power-On-Self-Test), on the system 900. This self-test can test the functionality of various hardware components such as hard disk drives, optical reading devices, cooling devices, memory modules, expansion cards, and the like. The firmware 934 can address and allocate an area in the memory 904, ROM 906, RAM 908, and/or storage device 912, to store an operating system (OS). The firmware 934 can load a boot loader and/or OS, and give control of the system 900 to the OS.

The firmware 934 of the system 900 can include a firmware configuration that defines how the firmware 934 controls various hardware components in the system 900. The firmware configuration can determine the order in which the various hardware components in the system 900 are started. The firmware 934 can provide an interface, such as an UEFI, that allows a variety of different parameters to be set, which can be different from parameters in a firmware default configuration. For example, a user (e.g., an administrator) can use the firmware 934 to specify clock and bus speeds; define what peripherals are attached to the system 900; set monitoring of health (e.g., fan speeds and CPU temperature limits); and/or provide a variety of other parameters that affect overall performance and power usage of the system 900. While firmware 934 is illustrated as being stored in the flash memory 932, one of ordinary skill in the art will readily recognize that the firmware 934 can be stored in other memory components, such as memory 904 or ROM 906.

System 900 can include one or more sensors 926. The one or more sensors 926 can include, for example, one or more temperature sensors, thermal sensors, oxygen sensors, chemical sensors, noise sensors, heat sensors, current sensors, voltage detectors, air flow sensors, flow sensors, infrared thermometers, heat flux sensors, thermometers, pyrometers, etc. The one or more sensors 926 can communicate with the processor, cache 928, flash memory 932, communications interface 924, memory 904, ROM 906, RAM 908, controller 910, and storage device 912, via the bus 902, for example. The one or more sensors 926 can also communicate with other components in the system via one or more different means, such as inter-integrated circuit (I2C), general purpose output (GPO), and the like. Different types of sensors (e.g., sensors 926) on the system 900 can also report to the controller 910 on parameters, such as cooling fan speeds, power status, operating system (OS) status, hardware status, and so forth. A display 936 may be used by the system 900 to provide graphics related to the applications that are executed by the controller 910.

FIG. 10 illustrates an example computer system 1000 having a chipset architecture that can be used in executing the described method(s) or operations, and generating and displaying a graphical user interface (GUI). Computer system 1000 can include computer hardware, software, and firmware that can be used to implement the disclosed technology. System 1000 can include a processor 1010, representative of a variety of physically and/or logically distinct resources capable of executing software, firmware, and hardware configured to perform identified computations. Processor 1010 can communicate with a chipset 1002 that can control input to and output from processor 1010. In this example, chipset 1002 outputs information to output device 1014, such as a display, and can read and write information to storage device 1016. The storage device 1016 can include magnetic media, and solid state media, for example. Chipset 1002 can also read data from and write data to RAM 1018. A bridge 1004 for interfacing with a variety of user interface components 1006, can be provided for interfacing with chipset 1002. User interface components 1006 can include a keyboard, a microphone, touch detection and processing circuitry, and a pointing device, such as a mouse.

Chipset 1002 can also interface with one or more communication interfaces 1008 that can have different physical interfaces. Such communication interfaces can include interfaces for wired and wireless local area networks, for broadband wireless networks, and for personal area networks. Further, the machine can receive inputs from a user via user interface components 1006, and execute appropriate functions, such as browsing functions by interpreting these inputs using processor 1010.

Moreover, chipset 1002 can also communicate with firmware 1012, which can be executed by the computer system 1000 when powering on. The firmware 1012 can recognize, initialize, and test hardware present in the computer system 1000 based on a set of firmware configurations. The firmware 1012 can perform a self-test, such as a POST, on the system 1000. The self-test can test the functionality of the various hardware components 1002-1018. The firmware 1012 can address and allocate an area in the memory 1018 to store an OS. The firmware 1012 can load a boot loader and/or OS, and give control of the system 1000 to the OS. In some cases, the firmware 1012 can communicate with the hardware components 1002-1010 and 1014-1018. Here, the firmware 1012 can communicate with the hardware components 1002-1010 and 1014-1018 through the chipset 1002, and/or through one or more other components. In some cases, the firmware 1012 can communicate directly with the hardware components 1002-1010 and 1014-1018.

It can be appreciated that example systems 900 (in FIG. 9) and 1000 can have more than one processor (e.g., 930, 1010), or be part of a group or cluster of computing devices networked together to provide greater processing capability.

As used in this application, the terms “component,” “module,” “system,” or the like, generally refer to a computer-related entity, either hardware (e.g., a circuit), a combination of hardware and software, software, or an entity related to an operational machine with one or more specific functionalities. For example, a component may be, but is not limited to being, a process running on a processor (e.g., digital signal processor), a processor, an object, an executable, a thread of execution, a program, and/or a computer. By way of illustration, both an application running on a controller, as well as the controller, can be a component. One or more components may reside within a process and/or thread of execution, and a component may be localized on one computer and/or distributed between two or more computers. Further, a “device” can come in the form of specially designed hardware; generalized hardware made specialized by the execution of software thereon that enables the hardware to perform specific function; software stored on a computer-readable medium; or a combination thereof.

The terminology used herein is for the purpose of describing particular embodiments only, and is not intended to be limiting of the invention. As used herein, the singular forms “a,” “an,” and “the” are intended to include the plural forms as well, unless the context clearly indicates otherwise. Furthermore, to the extent that the terms “including,” “includes,” “having,” “has,” “with,” or variants thereof, are used in either the detailed description and/or the claims, such terms are intended to be inclusive in a manner similar to the term “comprising.”

Unless otherwise defined, all terms (including technical and scientific terms) used herein have the same meaning as commonly understood by one of ordinary skill in the art. Furthermore, terms, such as those defined in commonly used dictionaries, should be interpreted as having a meaning that is consistent with their meaning in the context of the relevant art, and will not be interpreted in an idealized or overly formal sense unless expressly so defined herein.

While various embodiments of the present invention have been described above, it should be understood that they have been presented by way of example only, and not limitation. Although the invention has been illustrated and described with respect to one or more implementations, equivalent alterations and modifications will occur or be known to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application. Thus, the breadth and scope of the present invention should not be limited by any of the above described embodiments. Rather, the scope of the invention should be defined in accordance with the following claims and their equivalents.

What is claimed is:

1. A software deployment system comprising:
a deployment orchestrator coupled to a mobile network;
a plurality of end devices communicating with each other through the mobile network, wherein at least one of the end devices includes a support package repository storing software packages, wherein when a new end device requires software package deployment, the deployment orchestrator locates the at least one of the end device with the support package repository, and wherein the new end device receives software packages from the end device including the support package repository through the mobile network.

2. The system of claim 1, wherein the deployment orchestrator includes a database including hardware information and location information for each of the plurality of end devices.

3. The system of claim 2, wherein the new end device includes specific hardware requiring specific software packages, wherein the specific hardware includes at least one of the group of a camera, a microphone, and a Wi-Fi adaptor, and wherein the hardware information in the database of the new end device includes the specific hardware.

4. The system of claim 3, wherein the deployment orchestrator includes a package selector that determines software packages to support the specific hardware of the new end device.

5. The system of claim 1, wherein the deployment orchestrator includes a central repository including software packages required by any of the plurality of end devices.

6. The system of claim 5, wherein the deployment orchestrator creates a support package repository in one of the plurality of end devices from the central repository.

7. The system of claim 5, wherein the deployment orchestrator allows connection to the central repository for the deployment of software packages when no end device with a support package repository is available to the new end device.

8. The system of claim 2, wherein the deployment orchestrator includes a deployment conductor that collects the location of the new end device and the location of the at least one end device with the support package repository.

9. The system of claim 7, wherein the deployment orchestrator includes an alive agent monitor that determines whether the location of the end device including the support package repository has changed, wherein the alive agent monitor alerts the deployment conductor and locates another end device including the support package repository.

10. The system of claim 9, wherein the deployment of software packages to the new end device is initiated by the at least one end device and continued by the another end device.

11. A method of deploying software packages to a new end device in communication with a mobile network, the method comprising:
creating at least one support package repository in an end device of a plurality of end devices in communication with the mobile network, the support package repository storing software packages from a deployment orchestrator;
determining the new end device requires software deployment;
determining the location of the new end device and the end device having the support package repository;
deploying the software packages from the support package repository of the end device to the new end device.

12. The method of claim 11, further comprising storing hardware information and location information for each of the plurality of end devices in a database.

13. The method of claim 12, wherein the new end device includes specific hardware requiring specific software packages, wherein the specific hardware includes at least one of the group of a camera, a microphone, and a Wi-Fi adaptor, and wherein the hardware information in the database of the new end device includes the specific hardware.

14. The method of claim 13, where the software packages are determined based on the hardware information of the new end device in the database.

15. The method of claim 11, further comprising storing all software packages required by the plurality of end devices in a central repository.

16. The method of claim 15, further comprising connecting the new device to the central repository for the deployment of software packages when no end device with a support package repository is available to the new end device.

17. The method of claim 12, further comprising collecting location data of the new end device and the location of the at least one end device with the support package repository.

18. The method of claim 17, further comprising:
determining whether the location of the end device including the support package repository has changed; and
locating another end device including the support package repository.

19. The method of claim 18, wherein the deployment of software packages to the new end device is initiated by the at least one end device and continued by the located another end device.

20. A deployment orchestrator for deployment of software to a new end device coupled to a mobile network, the deployment orchestrator comprising:
a central repository storing software packages;
a deployment conductor coupled to the central repository;
a mobile network interface allowing communication between the deployment conductor and a plurality of end devices, wherein the end devices include at least one end device with a support package repository storing software packages from the central repository, and wherein the deployment conductor receives a notification of a new end device in communication with the mobile network;
a package selector coupled to the deployment conductor, the package selector determining software packages for the new end device; and
a location selector coupled to the deployment conductor, the location monitor determining the location of the new end device and the locations of the plurality of end devices, wherein the deployment conductor causes deployment of software packages from the at least one end device to the new end device.
